(19) United States
(12) Patent Application Publication
(10) Pub. No.: US 2008/0234441 A1
(43) Pub. Date: Sep. 25, 2008

(54) PROCESS FOR PRODUCING BIS-(AMINOALKYL)-POLYSILOXANES

(76) Inventors: Larry Allen Divins, Parkersburg, WV (US); Michael Powell, New Martinsville, WV (US); Tiberiu L. Simandan, Marietta, OH (US)

Correspondence Address: MOMENTIVE PERFORMANCE MATERIALS INC.;IP LEGAL, ONE PLASTICS AVENUE, BLDG. 51, PITTSFIELD, MA, 01201-3697, US

(21) Appl. No.: 11/750,361

(22) Filed: May 18, 2007

Related U.S. Application Data
(60) Provisional application No. 60/896,113, filed on Mar. 21, 2007.

(51) Int. Cl. C08F 285/00

(52) U.S. Cl. 525/478

(57) ABSTRACT

Bis(aminoalkyl)siloxane dimers or oligomers are prepared by a process utilizing hydrosilation of an olefinic amine with tetraorganodisiloxane or with bis(dialkylhydrogen)siloxane oligomers to generate high purity bis(aminoalkyl)disiloxane or bis(aminoalkyl)siloxane oligomers at high conversion yield, which may then be subsequently equilibrated to higher molecular weight bis(aminoalkyl)polysiloxanes.

### CROSS REFERENCE TO RELATED APPLICATIONS

This application claims the benefit of U.S. Provisional Application Ser. No. 60/896113 filed on Mar. 21, 2007.

### FIELD OF INVENTION

This invention relates to an improved process for the preparation of bis(aminoalkyl)siloxane dimers or oligomers and for the preparation of bis(aminoalkyl)polysiloxanes. Bis(aminoalkyl)polysiloxanes are useful diamine monomers for the production of block copolymers and are useful as softeners in hair care and textile formulations.

### BACKGROUND OF THE INVENTION

Commercial utilization of bis(aminoalkyl)polysiloxanes has been inhibited by their cost. Reported synthetic methods have low yields, require solvents, are complex, or form cyclic siloxanes requiring additional process steps to obtain the bis(aminoalkyl)polysiloxane product.

One approach to the production of bis(aminoalkyl)polysiloxanes has been the utilization of the end-blocker bis(aminoalkyl)disiloxane or other lower siloxane oligomers such as bis(aminoalkyl)trisiloxane and bis(aminoalkyl)tetrasiloxane and their equilibration with polydiorganosiloxane to form the desired polysiloxane. Generally, existing processes to produce the pure end-blocker bis(aminoalkyl)disiloxane or bis(aminoalkyl)siloxane oligomers have deficiencies.

For example, U.S. Pat. No. 5,026,890 describes three embodiments, in which complex steps are taken to process oligomers and cyclic siloxanes formed during the hydrosilation step. In one embodiment of the '890 patent, solvent is utilized to substantially dilute the hydrosilation reactants in order to maximize the yield of bis(aminoalkyl)disiloxane. However, byproduct cyclic disiloxazanes are formed and during the stripping of solvent and excess reactants from the products of the hydrosilation reaction, oligomers form from the cyclic disiloxazanes. To convert the oligomers to bis(aminoalkyl)polysiloxane, alcoholysis is conducted. To convert the cyclic disiloxazanes to bis(aminoalkyl)polysiloxane, hydrolysis is conducted. In a second embodiment of the invention of this patent, no solvent diluent is employed, but it is required that the siloxane reactant for hydrosilation must be of greater chain length than disiloxane. In a third embodiment also employed without a solvent diluent but also using a disiloxane reactant, undesirable alkenylaminodisiloxanes and oligomers are formed, the formation of which may be reversed if acid is introduced to form cyclic disiloxazanes, which can then be further processed with hydrolysis to obtain bis(aminoalkyl)polysiloxane. Although U.S. Pat. No. 5,026,890 teaches relatively high conversion yields to bis(aminoalkyl)polysiloxane, the formation of the end-blocker bis(aminoalkyl)disiloxane may only be achieved through the utilization of a diluent solvent.

J. L. Speier et al and J. C. Saam et al reported the utilization of protective group chemistry to avoid the formation of cyclic and oligomeric byproducts during the hydrosilation of tetramethyldisiloxane with allyamine compounds over fifty years ago. In a first step, the amine end of allyamine was protected with a trimethysilyl group using ammonium sulfate as catalyst (protection step). Following hydrosilation, the trimethylsilyl group was removed in an alcoholysis step (deprotection step). The end-blocker bis(aminoalkyl)disiloxane was isolated by distillation. The protection step had a reported yield of 70%. The hydrosilation and deprotection step had a reported yield of 78%. Therefore, the overall yield of the process was a poor 54.6%.

Other patents, likewise, report the utilization of complex steps or poor yields. U.S. Pat. No. 4,584,393 reports the formation of substantially pure bis(aminoalkyl)disiloxanes from the hydrosilation of monosilazanes to form an intermediate followed by hydrolysis of the intermediate. This process requires the preparation of the monosilazane from the hydrosilation reaction of a chlorosilane with olefinic amine in the presence of an acid acceptor followed by purification. However, the '393 patent does not report the product yield. U.S. Pat. No. 4,631,346 describes a process for converting silyl carbamates by hydrosilation and hydrolysis to bis(aminoalkyl)disiloxanes. The silyl carbamates are prepared by reacting carbon dioxide with silazanes, which are prepared from the hydrosilation reaction of olefinic amine with a chlorosilane. The yield to bis(aminoalkyl)siloxanes from the silyl carbamate was reported in the range of 82-84%. The yield to silyl carbamate from the starting chlorosilane was not reported. The product was reported to contain about 75% bis(aminoalkyl)disiloxane with the remainder being higher bis(aminoalkyl)siloxanes such as trisiloxane and tetrasiloxane. The processes of both the '393 and the '346 patent suffer from the need to employ two hydrosilation steps and are complicated by difficulties in handling highly reactive chlorosilanes. Furthermore a third similar patent, U.S. Pat. No. 4,649,208 reports low yields when the method of this patent is applied to the production of bis(aminoalkyl)disiloxanes.

According to U.S. Pat. No. 6,531,620, bis(aminoalkyl)disiloxanes may be prepared in high yields by the hydrolysis or alcoholysis of cyclic silazanes, which have been prepared from the amination of chlorosilanes. However, the amination of chlorosilanes is highly complex with the formation of salts and operation at high pressures.

Because of the difficulties in producing the end-blocker bis(aminoalkyl)disiloxane, at least one recent patent, U.S. Pat. No. 6,534,615 discloses an approach which avoids the use of bis(aminoalkyl)disiloxane. The patent describes the direct reaction of cyclic silazanes with bishydroxy-terminated polydiorganosiloxanes to make bis(aminoalkyl)polysiloxanes. To produce the cyclic silazanes, the patent '615 references the utilization of high-pressure amination of chlorosilanes or disilazanes, which is a highly complex process.

### SUMMARY OF THE INVENTION

The present invention provides for a batch or continuous process for preparing bis(aminoalkyl)disiloxanes or bis(aminopropyl)siloxane oligomers and for their utilization to prepare bis(aminoalkyl)polysiloxanes with said process conducted in an inert atmosphere comprising:

(A) silylating an olefinic amine (Reagent A) of the formula

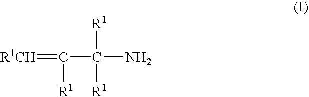

wherein each R¹ is independently hydrogen, C₁₋₄ primary or secondary alkyl, phenyl or substituted phenyl, with a trimethylsilyl protection group from a trimethyl silylation agent (Reagent B), in the presence of a catalytic amount of an acid catalyst (Reagent C), followed by stripping excess Reagent A from the silylated product,

(B) reacting the stripped product of the silylation reaction with at least one polydiorganohydrogensiloxane (Reagent D) of the formula:

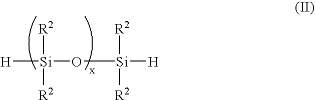

wherein R² is C₁₋₄ primary or secondary alkyl, phenyl, or substituted phenyl and x has a value of 1 to about 300, in the presence of a catalytic amount of a platinum-containing hydrosilation catalyst (Reagent E),

deprotecting the amine group and forming the desired bis(aminoalkyl)disiloxane or bis(aminoalkyl)siloxane oligomer by hydrolysis with water or alcoholysis with alcohol and optionally in the presence of a catalytic amount of an alkali catalyst (Reagent F),

recovering the trimethyl silyl protection groups in the form of hexamethyldisiloxane (deprotection by water hydrolysis) or in the form of trimethylalkoxysilane (deprotection with alcohol) by a distillation separation from the bis(aminopropyl)disiloxane or bis(aminopropyl)siloxane oligomer product, and

equilibrating the purified bis(aminopropyl)disiloxane or bis(aminopropyl)siloxane oligomer with at least one polydiorganosiloxane (Reagent G) in the presence of a catalytic amount of an alkali catalyst (Reagent H) in an appropriate molar ratio to form the desired bis(aminoalkyl)polysiloxane.

### DETAILED DESCRIPTION OF THE INVENTION

It has been discovered, surprisingly, that bis(aminoalkyl)disiloxane or bis(aminoalkyl)siloxane oligomers may be prepared in high yield and high purity and without the complexities of undesirable cyclic siloxanes formation. We have discovered better catalysts for the protection reaction, which in conjunction with using a greater molar excess of olefinic amine, produced trimethylsilyl protected olefinic amine in high yield. Furthermore, we discovered that by converting the deprotection reaction from alcoholysis to water hydrolysis, we could produce in high yield an easily purified bis(aminoalkyl)disiloxane or bis(aminoalkly)siloxane oligomer and at the same time recover the trimethylsilyl groups as a valuable byproduct, hexamethyldisiloxane. Additionally, we discovered that the process of this invention produces a higher quality bis(aminoalkly)disiloxane or bis(aminoalkyl)siloxane oligomer than previously observed. We found lower beta-isomer formation, less odor, and water-white color.

The present invention is directed at a method for preparing bis(aminoalkyl)disiloxanes or bis(aminoalkyl)siloxane oligomers and for their utilization to prepare bis(aminoalkyl)polysiloxanes comprising:

(A) the reaction product of an olefinic amine (Reagent A) of the formula

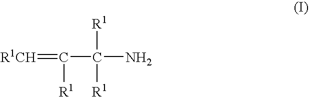

wherein each R¹ is independently hydrogen, C₁₋₄ primary or secondary alkyl, phenyl or substituted phenyl, with a trimethyl silylation reagent comprising a trimethylsilyl protection group (Reagent B), hereinafter referred to as a silylation reaction (to protect the amine group), in the presence of a catalytic amount of an acid catalyst (Reagent C), followed by stripping excess Reagent A from the product of the silylation reaction, hereinafter the silylated product,

(B) reacting the stripped product of the silylation reaction with at least one polydiorganohydrogensiloxane (Reagent D) of the formula

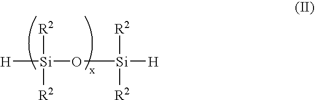

wherein each R² is independently C₁₋₄ primary or secondary alkyl, phenyl, or substituted phenyl and x has an preferred value of 1, or optionally from 2 to about 300, in the presence of a catalytic amount of a platinum-containing hydrosilation catalyst (Reagent E),

(C) deprotecting the amine group and forming the desired bis(aminoalkyl)disiloxane or bis(aminoalkyl)siloxane oligomer by hydrolysis with water or optionally with alcohol and optionally in the presence of a catalytic amount of an alkali catalyst (Reagent F),

(D) recovering the trimethyl silyl protection groups in the form of hexamethyldisiloxane (deprotection by water hydrolysis) or in the form of trimethylalkoxysilane (deprotection with alcohol) by distillation separation from the bis(aminopropyl)disiloxane product, and

(E) equilibrating the purified bis(aminopropyl)disiloxane or bis(aminopropyl)siloxane oligomer with at least one polydiorganosiloxane (Reagent G) in the presence of a catalytic amount of an alkali catalyst (Reagent H) in an appropriate molar ratio to form the desired bis(aminoalkyl)polysiloxane.

Reagent A in the method of this invention is a least one olefinic amine of formula I. Suitable amines include allylamine, methallylamine and 2-butenylamine. Allylamine is preferred.

Reagent B is at least one trimethyl silylation agent selected from the group of trimethylchlorosilane, trimethylalkoxysilane, hexamethyldisilazane, trimethylsilylamides, and trimethylsilylamines. Preferred are trimethylchlorosilane, trimethylalkoxysilane, and hexamethyldisilazane. Hexamethyldisilazane is most preferred.

Reagent C is a least one acid catalyst suitable for promoting the trimethyl silylation reaction selected from the group of sulfuric acid, organosulfuric acid (e.g p-toluenesulfonic acid), hydrochloric acid, chlorosilanes, ammonium sulfate, ammonium chloride, and chloroacetic acids. Chlorosilanes are preferred and trimethylchlorosilane is most preferred when hexamethyldisilazane is used as the trimethyl silylation agent.

Reagent D is at least one polydiorganohydrogensiloxane of formula II. The 1,1,3,3-tetraalkyldisiloxanes and especially 1,1,3,3-tetramethyldisiloxane are preferred. Optionally, it may be advantageous to use higher siloxanes, up to an average molecular weight in the range of 15,000-20,000.

Reagent E is a platinum-containing hydrosilation catalyst. Many such catalysts are known in the art, and any of them may be employed in the present invention. They include chloroplatinic acid, chloroplatinic acid-olefin complexes, platinum complexes with olefins, platinum complexes with olefinic polysiloxanes, platinum on various supports such as alumina and silica, and platinum black. Preferred are chloroplatinic acid and platinum complexes with vinyl-substituted polydiorganosiloxanes. Most preferred are platinum complexes with vinyl-substituted polydiorganosiloxanes.

Reagent F is a water soluble alkali metal, metal alkoxide, or ammonia base that may advantageously be used to promote hydrolysis or alcoholysis.

Reagent G is at least one polydiorganosiloxane selected from the group of cyclic siloxanes. A preferred cyclic polydimethylsiloxane is octamethylcyclotetrasiloxane, more commonly known as tetramer or D₄.

Reagent H is a basic equilibration catalyst. Many such catalysts are known in the art for the polymerization of polyorganosiloxanes and any of them may be employed in the present invention. They include hydroxides, phenolates, and siloxanolates (or silanolates) of the alkali metals and quaternary ammonium and phosphonium bases and their siloxanolates (or silanolates). Preferred are the alkali metal siloxanolates (or silanolates), the thermally labile or transient quaternary ammonium and phosphonium bases and their siloxanolates (or silanolates), 3-aminopropyl dimethyl tetramethylammonium silanolate disclosed in European Patent 0250248 and in U.S. Pat. No. 5,214,119, the disclosures of which are incorporated by reference herein, and 3-aminopropyl dimethyl tetrabutylphosphonium silanolate.

Michael B. Smith in the Introduction to Chapter 7 of Organic Synthesis, Second Edition (McGraw-Hill, New York, 2002, p. 537) defines protective group chemistry in the following manner: “Many problems arise during a synthesis. Some synthetic targets contain more than one functional group and if they interact with each other or if one group reacts with a reagent competitively with another group, the synthesis can be in serious trouble. One practical solution to such problems is to temporarily block a reactive position by transforming it into a new functional group that will not interfere with the desired transformation. That new blocking group is called a protecting group. This process requires at least two chemical reactions. The first reaction transforms the interfering functional group into a different one, which will not compete with the desired reaction, which is termed protection. The second chemical step transforms the new functional group (i.e. the protecting group) back into the original group at a later stage of the synthesis. This latter process is termed deprotection.” In the instant patent application describing the instant invention the words “protection” and “deprotection” are used with the meaning given them in the Smith quotation, supra.

The protection reaction of Step A may be conveniently conducted in a reactor heated to reflux. Olefinic amine and the trimethyl silylation agent are mixed in a molar ratio that utilizes a molar excess of amine. Through a mass action effect, the excess amine drives the silylation reaction to the desired placement of one trimethylsilyl protection group on the amine. If the reaction is not in molar excess, two trimethylsilyl groups may be placed on part to all of the amine, thereby forming a second product. For the preferred example of the allylamine reaction with hexamethyldisilazane, the stoichiometric molar ratio is 2.0 to theoretically form trimethylsilylallylamine. We have found that the molar ratio should exceed 2.0 to drive the reaction to the preferred trimethylsilylallylamine. Otherwise, the reaction will form a proportion of allylhexamethyldisilazane, which contains two trimethylsilyl groups. We have discovered that having a high proportion of trimethylsilylallylamine improves the yield and reaction rate of Step B, the hydrosilation reaction. Additionally we discovered that strong acid catalysts improve the yield of the protection reaction. For the preferred example of the allylamine reaction with hexamethyldisilazane, we found that catalytic amounts of trimethylchlorosilane substantially improved the yield and reaction rate of the protection reaction. Prior to proceeding to the hydrosilation reaction of Step B, excess olefinic amine should be stripped from the protection reaction product. The excess amine may simply be reused in the next protection reaction without significant adverse effects. We have found that it is not necessary to remove any excess trimethylsilylation agent from the silylated product. This simplifies the stripping step.

Step B involves the hydrosilation of a polyldiorganohydrogensiloxane of formula II with the trimethylsilyl protected olefinic amine from Step A using standard platinum catalysts. If the product of Step A is an olefinic amine protected with only one trimethylsilyl group, we have found that the hydrosilation proceeds quickly to high yields. We have also found that if the molar ratio of the two reactants is controlled to a stoichiometric ratio, both reactants will convert to high yields. We have generally found the presence of two alpha isomer products and a small amount of corresponding beta isomer products. The second product apparently comes from having excess trimethylsilylation agent present in the hydrosilation reaction. This apparently results in some of the desired primary product adding a second trimethylsilyl group to the amine. Having two primary products after the hydrosilation reaction is not a problem in that it does not cause an eventual yield loss in the process because the water hydrolysis reaction of Step C converts both hydrosilation products to the desired bis(aminopropyl)disiloxane. One of the advantages of the improved process is a substantially lower formation of beta isomer than present materials. We believe that the trimethylsilyl protection of the olefinic amine sufficiently changes the electronics of the protected amine to shift the hydrosilation reaction more to the alpha position.

Conducting the deprotection reaction of Step C with water hydrolysis instead of alcoholysis cleanly converts the products of hydrosilation to the desired bis(aminopropyl)disiloxane or bis(aminopropyl)siloxane oligomers at high yield. And furthermore, the hydrolysis reaction converts the freed trimethylsilyl groups to valuable hexamethyldisiloxane. The siloxane products form an oil phase, which may be decanted from the water phase.

Distillation Step D separates bis(aminopropyl)disiloxane or bis(aminopropyl)siloxane oligomer product from byproduct hexamethyldisiloxane (deprotection by water hydrolysis) or byproduct trimethylalkoxysilane (deprotection with alcohol). A high purity bis(aminopropyl)disiloxane or bis(aminopropyl)siloxane oligomer is easily achieved.

The equilibration polymerization reaction of Step E to form bis(aminopropyl)polysiloxane is best conducted using anhydrous reactants. Cyclic polydiorganosiloxane is reacted with a controlled amount of bis(aminopropyl)disiloxane or bis(aminopropyl)siloxane oligomer in the presence of a catalytic amount of an anhydrous, strong base catalyst at elevated temperature in an inert atmosphere to form bis(aminopropyl)polysiloxane of the desired molecular weight. The molecular weight is controlled by the amount of bis(aminopropyl)disiloxane or bis(aminopropyl)siloxane oligomer endstopper. The reaction may be conducted in one batch stage, multiple batch stages, or continuously. Multiple stage and continuous polymerization will generally be quicker if molecular weight is increased in steps to the ultimate target.

We have observed that single stage equilibration polymerization of bis(aminopropyl)disiloxane endstopper with cyclic polydiorganosiloxane results in higher than expected molecular weights and without wishing to be bound by theory we hypothesize that this is a result of an incomplete incorporation of the endstopper. This occurs regardless of whether or not a stoichiometric excess of the endstopper is utilized. However we have found that making a low molecular weight bis(aminopropyl)polysiloxane product having a molecular weight of about 2000 (“n” equals approximately 24) or less is accomplished by injecting additional endstopper near the end of equilibrium completion. This staged injection may be accomplished multiple times to achieve a very low molecular weight. If a thermally labile catalyst is being utilitized, it may be advantageous to inject more catalyst at the time of additional endstopper injection(s). After completion of the polymerization equilibration, the excess endstopper may be simply stripped from the product by vacuum distillation after the catalyst has been deactivated.

The amount of catalyst employed is generally less than 0.5 weight percent and preferably 0.0025 to about 0.05 weight percent of the reactants weight. Reaction temperature depends on the catalyst employed. If a thermally labile or transient catalyst is utilized, the reaction temperature will typically be in the range of 80° C. to 130° C. The transient catalyst is then deactivated by heating the reaction product above 130° C. to decompose the catalyst. If an alkali metal catalyst (hydroxide, silanolate, or phenolate) is utilitzed, the reaction temperature may be higher. However too high of a temperature may increase product color. Alkali metal catalysts are typically deactivated by neutralization.

This invention is further disclosed by means of the following examples. It is understood, however, that the invention is not limited solely to the particular Examples given below:

### COMPARATIVE EXAMPLE 1

This example is intended to be a duplication of the work of Speier, Saam, et al to provide a reference baseline for the improvements of this invention. Various sized 4-neck round bottom flasks equipped with a magnetic stirrer, cold-finger distillation head, thermocouple connected to a temperature controller, nitrogen purge tube, and water ice plus dry ice traps on the vent were utilized for the steps of this example.

A. Allylamine Protection Reaction

This data represents the results of three experimental runs in a 2-liter reaction flask. In total, 1342.30 grams of allylamine, 989.00 grams of hexamethyldisilazane, and 517.32 grams of ammonium sulfate were charged to the reactor and slowly heated to 70° C. while maintaining a total reflux return to the reactor. The reaction was monitored by gas chromatograph until product formation stopped. After filtration of the ammonium sulfate salt, the reaction mixture was analyzed by gas chromatography and was found to contain 69.4% trimethylsilylallylamine for a total amount of 858.73grams trimethylsilylallylamine in the crude product mixture. This represents a reaction yield of 83.2% based on the net amount of hexamethyldisilazane consumed. The crude product mixture was distilled atmospherically at a 120° C. pot temperature and 114° C. head temperature using a 5-tray jacketed Oldershaw column. This was done three times. Product cuts from the first-pass distilling that were less than 90% purity were combined and re-distilled. Based on the charged amount of trimethylsilylallylamine, the distillation yield was 89.5%.

B. Hydrosilation Reaction

317.10 grams of tetramethyldisiloxane was fed into 637.62 grams of distilled trimethylsilylallylamine containing 0.83 grams of Karstedt's catalyst (0.0398 grams of platinum) to form alpha and beta isomers of the products bis(trimethylsilylaminopropyl)tetramethyldisiloxane and bis(hexamethyldisilylaminopropyl)tetramethyldisiloxane. The temperature of the reaction was maintained between 105° C. and 127° C. throughout the tetramethyldisiloxane feed and then held at 115° C. afterward. The time of reaction completion was under 4 hours. The reaction mixture was analyzed by gas chromatography and was found to contain 78.7% combined alpha isomer and beta isomer products. Based on the charged amount of trimethylsilylallylamine, this represents a reaction yield of 90.1%.

C. Alcoholysis Deprotection Reaction

Deprotection of the blocked amine was accomplished with alcohol. 234.27 grams of methanol was slowly charged to a reaction flask containing 842.79 grams of the product of the hydrosilation reaction of Step “B” while maintaining the reactor temperature below 50° C. When all the methanol had been added and the exothermic reaction ceased, the reactor was heated to reflux and held for two hours. The reaction product was analyzed by gas chromatography and was found to contain 35.82% of the desired product, bis(aminopropyl)tetramethyldisiloxane and 32.48% of the byproduct hexamethyldisiloxane. Based on the charged amount of protected product, a yield of 91.9% was achieved. The product mixture was distilled using similar equipment as in the prior Step “A” distillation except vacuum conditions were employed. The distillation was accomplished with a pot temperature of 180° C. and a pressure of 6 mm Hg. The distillation yield of bis(aminopropyl)tetramethyldisiloxane was 94.1%.

The overall reaction yield for the three reaction steps of this example is 68.9%. Including the distillation steps the total process yield is 58.0%.

### PRACTICAL EXAMPLE 1

This example illustrates the improvements of this invention.

A. Allylamine Protection Reaction

Into a 2-liter round bottom flask equipped with a magnetic stirrer, cold-finger distillation head, thermocouple connected to a temperature controller, nitrogen purge tube, and water ice plus dry ice traps on the vent, were charged 433.32 grams of allylamine, 300.25 grams of hexamethyldisilazane, and 1.76 grams of trimethylchlorosilane catalyst. The reactor was slowly heated to 65-70° C. while maintaining a total reflux return to the reactor. The reaction was monitored by gas chromatograph until product formation stopped. Typically, the reaction was completed in less than 4 hours. The flask contents were then stripped at atmospheric pressure to remove excess allylamine. By gas chromatograph analysis, the flask was found to contain 422.50 grams of trimethylsilylallylamine in the crude product mixture. Based on the net amount of hexamethyldisilazane, this represents a reaction yield of 94.5%. The crude product mixture was distilled at atmospheric pressure at a 120° C. pot temperature and 114° C. head temperature using a 5-tray jacketed Oldershaw column. Based on the charged amount of trimethylsilylallylamine, the distillation yield was 95.7%.

B. Hydrosilation Reaction

288.59 grams of tetramethyldisiloxane was slowly charged via an addition funnel to a 2-liter round bottom flask containing 504.90 grams of trimethylsilylallylamine and 0.60 grams of Karstedt's catalyst (0.0288 grams of platinum). The temperature of the reaction was maintained between 88° C. and 95° C. throughout the tetramethyldisiloxane feed and then held at 90° C. afterward. The time of reaction completion was 3 hours. The total amount of alpha and beta isomers of bis(trimethylsilylaminopropyl)tetramethyldi-siloxane and bis(hexamethyldisilylaminopropyl)tetramethyldisiloxane products formed was 674.28 grams, which represents a reaction yield of 87.9% based on the charged amount of trimethylsilylallyamine.

C. Hydrolysis Deprotection Reaction

Ion exchange treated water at room temperature was slowly fed via an addition funnel into a 2-liter round bottom flask containing 822.39 grams of the crude hydrosilation product. The reaction temperature was monitored and the addition of water was slow at first to prevent generated alcohol from boiling over. At 11% of the total water feed of 350.74 grams, the reaction had an exotherm to 78° C. After the remainder of the water was added, the reaction was held at 80° C. for 1 hour. The reactor contents were then charged to a separatory funnel and the water and product layers were decanted. 950.19 grams of crude product (top layer) was separated. By gas chromatograph analysis, the crude product was found to contain 395.47 grams of the desired deblocked product, bis(aminopropyl)tetramethyldi-siloxane which represents a hydrolysis reaction yield of 92.7%. The crude product was found to also contain 375.13 grams of the byproduct, hexamethyldisiloxane. The product mixture was distilled using similar equipment as in the prior Step “A” distillation except vacuum conditions were employed. The distillation was accomplished with a pot temperature of 180° C. and a pressure of 8 mm Hg. The distillation yield of bis(aminopropyl)tetramethyldisiloxane was 97.7%.

The overall reaction yield for the three reaction steps of the example of this invention is 77.0% vs. the 68.9% yield of the comparative example. Including the distillation steps, the total process yield is 72.0% vs. the 58.0% yield of the comparative example.

The distilled bis(aminopropyl)tetramethyldisiloxane was found by ¹³C NMR to contain 2.4% beta isomer, which is substantially less than the 15-18% content observed in present commercial samples. The distilled bis(aminopropyl)tetramethyldisiloxane was water-white and of low odor.

### PRACTICAL EXAMPLE 2

This example illustrates the utilization of the bis(aminopropyl)tetramethyldisiloxane endstopper from Practical Example 1 to prepare a low molecular weight bis(aminopropyl)polysiloxane. Into a 250 cc round bottom flask equipped with a magnetic stirrer, cold-finger distillation head, thermocouple connected to a temperature controller, nitrogen purge tube, and water ice plus dry ice traps on the vent, were charged 27.66 grams of 98.19% pure bis(aminopropyl)tetramethyldisiloxane, 81.12 grams of vacuum distilled and dehydrated octamethylcyclotetrasiloxane, and 0.23 grams of anhydrous tetramethylammonium hydroxide. The mixture was heated to 130° C. and held at that temperature for 22 hours. At that point, an additional 4.18 grams of bis(aminopropyl)tetramethyldisiloxane and 0.14 grams of anhydrous tetramethylammonium hydroxide was charged. The purpose of the second injection of the endstopper and catalyst was to force the equilibration to the low molecular weight. The mixture was then held at 130° C. for 20 hours and then the catalyst was decomposed by heating at 160° C. for one hour. After removal of cyclic siloxanes and excess bis(aminopropyl)tetramethyldisiloxane by vacuum stripping, the molecular weight of the product was determined by amine content acid titration to be 900. Compared to the yellow color and strong odor of present commercial bis(aminopropyl)polysiloxane of similar molecular weight, the product prepared according to this Example was water-white and of low odor.

### PRACTICAL EXAMPLE 3

This example illustrates the utilization of the 900 molecular weight bis(aminopropyl)siloxane of Practical Example 2 to prepare a high molecular weight bis(aminopropyl)polysiloxane. To a 1 liter, 4-neck flask with an air-driven stirrer utilizing a Teflon blade, cold water condenser/distillation head, thermocouple connected to a temperature controller, and nitrogen purge tube, were charged 522.31 grams of dehydrated, vaccum distilled octamethylcyclotetrasiloxane and 9.35 grams of said bis(aminopropyl)trisiloxane. The mixture was heated to 105° C. and catalyzed with 0.27 grams of anhydrous tetramethylammonium hydroxide. The catalyzed mixture was held for 23 hours and sampled for viscosity. The viscosity indicated that the equilibrium polymerization was completed. The mixture was then heated to 170° C. to decompose the catalyst, vacuum was pulled to 18 mm Hg, and held at those conditions for 2 hours to distill residual cyclic siloxanes from the material. Then the vacuum was broken with nitrogen and the product was cooled. Approximately 37.0 grams of lights were removed and 451 grams of product were bottled. The molecular weight of the product was determined to be 54,945 by amine content acid titration. The viscosity of the product was 13,800 centipoise. The product was water-white in appearance and had low odor.

### PRACTICAL EXAMPLE 4

This example illustrates the utilization of bis(aminopropyl)siloxane oligomer to prepare a high molecular weight bis(aminopropyl)polysiloxane. The utilized oligomer was prepared according to the procedure of Practical Example 2 and had a molecular weight of 460 or approximately the structure of bis(aminopropyl)trisiloxane. To a 1 liter flask with an air-driven stirrer utilizing a Teflon blade, cold water condenser/distillation head, thermocouple connected to a temperature controller, and nitrogen purge tube, were charged 571.30 grams of dehydrated, vaccum distilled octamethylcyclotetrasiloxane and 5.17 grams of said bis(aminopropyl)trisiloxane. The mixture was heated to 105° C. and catalyzed with 1.02 grams of 25 wt. percent tetramethylammonium hydroxide in water. The catalyzed mixture was held between 103° C. and 113° C. for 17 hours and sampled for viscosity. The viscosity indicated that the equilibrium polymerization was completed. The mixture was then heated to 150-160° C. to decompose the catalyst, vacuum was pulled to 9 mm Hg, and held at those conditions for 2 hours to distill residual cyclic siloxanes from the material. Then the vacuum was broken with nitrogen and the product was cooled. The molecular weight of the product was determined to be 50,600 by amine content acid titration and the viscosity of the product was 11,440 centripoise. The product was water-white in appearance and had low odor.

What is claimed is:

1. A batch or continuous process for preparing bis(aminoalkyl)disiloxanes or bis(aminopropyl)siloxane oligomers or bis(aminoalkyl)polysiloxanes,said process conducted in an inert atmosphere comprising:
(A) silylating an olefinic amine (Reagent A) of the formula 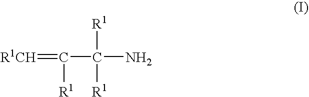
wherein each R¹ is independently hydrogen, C₁₋₄ primary or secondary alkyl, phenyl or substituted phenyl, with a trimethylsilyl protection group from a trimethyl silylation agent (Reagent B), in the presence of a catalytic amount of an acid catalyst (Reagent C), followed by stripping excess Reagent A from the silylated product,
(B) reacting the stripped product of the silylation reaction with at least one polydiorganohydrogensiloxane (Reagent D) of the formula 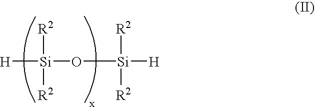
wherein R² is C₁₋₄ primary or secondary alkyl, phenyl, or substituted phenyl and x has a value of 1 to about 300, in the presence of a catalytic amount of a platinum-containing hydrosilation catalyst (Reagent E),
(C) deprotecting the amine group and forming the desired bis(aminoalkyl)disiloxane or bis(aminoalkyl)siloxane oligomer by hydrolysis with water or alcoholysis with alcohol and optionally in the presence of a catalytic amount of an alkali catalyst (Reagent F),
(D) recovering the trimethyl silyl protection groups in the form of hexamethyldisiloxane (deprotection by water hydrolysis) or in the form of trimethylalkoxysilane (deprotection with alcohol) by a distillation separation from the bis(aminopropyl)disiloxane or bis(aminopropyl)siloxane oligomer product, and
(E) equilibrating the purified bis(aminopropyl)disiloxane or bis(aminopropyl)siloxane oligomer with at least one polydiorganosiloxane (Reagent G) in the presence of a catalytic amount of an alkali catalyst (Reagent H) in an appropriate molar ratio to form the desired bis(aminoalkyl)polysiloxane.

2. The process of claim 1 wherein Reagent A comprises at least one olefinic amine of formula I.

3. The process of claim 2 wherein the olefinic amine is allylamine, methallylamine or 2-butenylamine.

4. The process of claim 1 wherein Reagent B comprises at least one trimethyl silylation agent selected from the group of trimethylchlorosilane, trimethylalkoxysilane, hexamethyldisilazane, trimethylsilylamides, and trimethylsilylamines.

5. The process of claim 1 wherein Reagent C comprises at least one acid catalyst suitable for promoting the trimethyl silylation reaction selected from the group of sulfuric acid, organosulfuric acid (e.g p-toluenesulfonic acid), hydrochloric acid, chlorosilanes, ammonium sulfate, ammonium chloride, and chloroacetic acids.

6. The process of claim 5 wherein the chorosilane is trimethylchlorosilane when hexamethyldisilazane is used as the trimethyl silylation agent.

7. The process of claim 1 wherein Reagent D comprises at least one polydiorganohydrogensiloxane of formula II.

8. The process of claim 7 wherein x=1 and the polydiorganohydrogensiloxanes is 1,1,3,3-tetraalkyldisiloxane.

9. The process of claim 8 wherein the 1,1,3,3-tetraalkyldisiloxane is 1,1,3,3-tetramethyldisiloxane.

10. The process of claim 1 wherein Reagent E is a platinum-containing hydrosilation catalyst selected from the group consisting of chloroplatinic acid, chloroplatinic acid-olefin complexes, platinum complexes with olefins, platinum complexes with olefinic polysiloxanes, platinum on various supports such as alumina and silica, and platinum black.

11. The process of claim 1 wherein Reagent F is a water soluble alkali metal, metal alkoxide, or ammonia base that may advantageously be used to promote hydrolysis or alcoholysis.

12. The process of claim 1 wherein Reagent G is at least one polydiorganosiloxane selected from the group of cyclic siloxanes.

13. The process of claim 12 wherein the cyclic polydimethylsiloxane is octamethylcyclotetrasiloxane.

14. The process of claim 1 wherein Reagent H is a strong base equilibration catalyst employed for the polymerization of polyorganosiloxanes.

15. The process of claim 14 wherein the strong base equilibration catalyst is selected from the group of hydroxides, phenolates, and silanolates (or siloxanolates) of the alkali metals; quaternary ammonium and phosphonium bases and their silanolates (or siloxanolates); 3-aminopropyl dimethyl tetramethylammonium silanolate, and 3-aminopropyl dimethyl tetrabutylphosphonium silanolate.

16. The process of claim 1 wherein the bis(aminopropyl)polysiloxane equilibration of Step E has staged additions of cyclic polydiorganosiloxane and/or catalyst for higher molecular weight products above about a molecular weight of 2000 and staged additions of bis(aminopropyl)disiloxane or bis(aminopropyl)siloxane oligomer endstopper and/or catalyst for bis(aminopropyl)polysiloxane products below a molecular weight of about 2000.

17. The process of claim 1 wherein the reactions are performed in the absence of an added solvent.

18. The process of claim 1 wherein one or more of the reactions are performed in the presence of a hydrocarbon solvent.
